(19) United States
(12) Patent Application Publication
(10) Pub. No.: US 2023/0299645 A1
(43) Pub. Date: Sep. 21, 2023

(54) ELECTRIC MOTOR CONTROLLER

(71) Applicant: Paul Behm, Brooksville, FL (US)

(72) Inventor: Paul Behm, Brooksville, FL (US)

(21) Appl. No.: 17/698,984

(22) Filed: Mar. 18, 2022

(51) Int. Cl. H02K 11/215; H02K 11/33; H02P 27/08; H02K 29/08

(52) U.S. Cl. CPC H02K 11/215; H02K 11/33; H02P 27/08; H02K 29/08

(57) ABSTRACT

Electric motor controllers including MOSFET transistors and Hall effect switches are described.

### FIELD

Some implementations relate generally to electric motor controllers, and, more particularly, to a simplified electric motor controller including MOSFET transistors and Hall effect switches.

### BACKGROUND

Some conventional electric motor controllers may be relatively expensive and may include numerous components that can lead to a higher failure rate, especially when exposed to harsh environment, such as salt air found on sailboats and other vessels operated on or near salt water.

Embodiments were conceived in light of the above-mentioned problems and limitations, among other things. The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include an electric motor controller comprising an n-channel MOSFET connected to a first p-channel MOSFET, ground, and a first motor coil, where the first p-channel MOSFET is connected to a pulse width modulation signal, and a diode. The motor controller also includes a second p-channel MOSFET connected to the first p-Channel MOSFET via the diode, a second motor coil, and a positive voltage source. The motor controller further includes a directional switch; a first hall effect sensor connected to the first motor coil, the directional switch, and the second p-channel MOSFET; and a second hall effect sensor connected to the directional switch, the first motor coil, and the second p-channel MOSFET.

The first Hall effect sensor and the second Hall effect sensor are configured to detect a magnetic field of the motor. The first motor coil is connected to ground and to the second p-channel MOSFET, and, in some implementations, the second motor coil is connected to the positive voltage source and the n-channel MOSFET.

In some implementations, the directional switch includes a manual switch. In some implementations, the directional switch includes a relay.

In some implementations, the pulse width modulation signal is generated by a discrete signal generator. In some implementations, the pulse width modulation signal is generated by a processor. In some implementations, the second p-channel MOSFET and the n-channel MOSFET are connected to one or more additional MOSFET stages. The electric motor can be a permanent magnet electric motor or an electromagnet magnet electric motor.

Some implementations can include an electric motor controller comprising an n-channel MOSFET connected to a first p-channel MOSFET, ground, and a first motor coil, wherein the first p-channel MOSFET is connected to a pulse width modulation signal, and a diode. The motor controller can also include a second p-channel MOSFET connected to the first p-Channel MOSFET via the diode, a second motor coil, and a positive voltage source. The motor controller can further include a directional switch; a first hall effect sensor connected to the first motor coil, the directional switch, and the second p-channel MOSFET; and a second hall effect sensor connected to the directional switch, the first motor coil, and the second p-channel MOSFET.

The first Hall effect sensor and the second Hall effect sensor are configured to detect a magnetic field of an electric motor. Some implementations can include two or more independent motor coils. The first motor coil is connected to ground and to the second p-channel MOSFET, and, in some implementations, the second motor coil is connected to the positive voltage source and the n-channel MOSFET.

The directional switch includes a manual switch, a relay, or a control signal from a processor. The pulse width modulation signal is generated by a discrete signal generator circuit or a processor. The electric motor is a permanent magnet electric motor or an electromagnet magnet electric motor.

### BRIEF DESCRIPTION OF THE DRAWINGS

FIG. 1 is a diagram of an example motor controller in accordance with some implementations.

### DETAILED DESCRIPTION

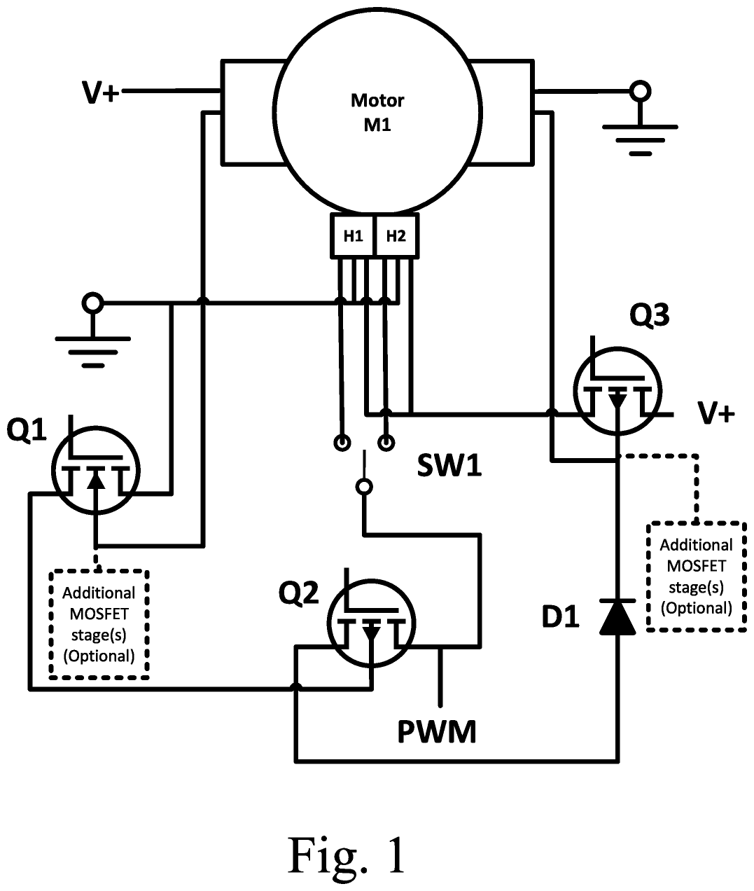

FIG. 1 shows a diagram of an example electric motor controller 100 that includes an n-channel MOSFET Q1 connected to a first p-channel MOSFET Q2, ground, and a first motor coil, wherein the first p-channel MOSFET Q2 is connected to a pulse width modulation signal, and a diode D1. The motor controller also includes a second p-channel MOSFET Q3 connected to the first p-Channel MOSFET Q2 via the diode D1, a second motor coil, and a positive voltage source V+. The motor controller further includes a directional switch SW1, and a first hall effect sensor H1 connected to the first motor coil, the directional switch SW1, and the second p-channel MOSFET Q3. The motor controller also includes a second Hall effect sensor H2 connected to the directional switch SW1, the first motor coil, and the second p-channel MOSFET Q3.

In operation, the first Hall effect sensor H1 and the second Hall effect sensor H2 are configured to detect a magnetic field of the electric motor M1. For example, the magnets in the motor can include two semicircular magnets with two gaps between the two semicircular magnets (e.g., two semicircular magnets that have a gap between each pair of corresponding ends of the magnets). The Hall effect sensors can detect as each magnetic field passes the Hall effect sensors.

Some implementations can include two or more independent motor coils. The first motor coil is connected to ground and to the second p-channel MOSFET Q3. The second motor coil is connected to the positive voltage source and the n-channel MOSFET Q1.

In some implementations, the directional switch SW1 includes a manual switch or a relay. The switching function of SW1 could also be performed by a processor such as a microcontroller or the like.

In some implementations, the pulse width modulation (PWM) signal is generated by a discrete signal generator, or a processor.

In some implementations, the second p-channel MOSFET Q3 and the n-channel MOSFET Q1 can be connected to one or more additional MOSFET stages per motor coil. Use of the MOSFETs as arranged in FIG. 1 helps to avoid the use of the conventional H-bridge arrangement, which would require 4 MOSFETs per motor coil.

The electric motor M1 can be a permanent magnet electric motor or an electromagnet magnet electric motor. Further, the electric motor can be a brushed (e.g., using slip ring brushes or the like as opposed to commutated brushes) or brushless dc motor. Also, the electric motor can be a radial or axial electric motor.

While some example implementations have been described in terms of a general embodiment with several specific example modifications, it is recognized that other modifications and variations of the embodiments described above are within the spirit and scope of the disclosed subject matter. Applicant intends to embrace any and all such modifications, variations and embodiments.

What is claimed is:

1. An electric motor controller comprising:
an n-channel MOSFET connected to a first p-channel MOSFET, ground, and a first motor coil, wherein the first p-channel MOSFET is connected to a pulse width modulation signal, and a diode;
a second p-channel MOSFET connected to the first p-Channel MOSFET via the diode, a second motor coil, and a positive voltage source;
a directional switch;
a first hall effect sensor connected to the first motor coil, the directional switch, and the second p-channel MOSFET; and
a second hall effect sensor connected to the directional switch, the first motor coil, and the second p-channel MOSFET,
wherein the first Hall effect sensor and the second Hall effect sensor are configured to detect a magnetic field of an electric motor,
wherein the first motor coil is connected to ground and to the second p-channel MOSFET, and
wherein the second motor coil is connected to the positive voltage source and the n-channel MOSFET.

2. The electric motor controller of claim 1, wherein the directional switch includes a manual switch.

3. The electric motor controller of claim 1, wherein the directional switch includes a relay.

4. The electric motor controller of claim 1, wherein the pulse width modulation signal is generated by a discrete signal generator.

5. The electric motor controller of claim 1, wherein the pulse width modulation signal is generated by a processor.

6. The electric motor controller of claim 1, wherein the second p-channel MOSFET and the n-channel MOSFET are connected to one or more additional MOSFET stages.

7. The electric motor controller of claim 1, wherein the electric motor is a permanent magnet electric motor.

8. The electric motor controller of claim 1, wherein the electric motor is an electromagnet magnet electric motor.

9. An electric motor controller comprising:
an n-channel MOSFET connected to a first p-channel MOSFET, ground, and a first motor coil, wherein the first p-channel MOSFET is connected to a pulse width modulation signal, and a diode;
a second p-channel MOSFET connected to the first p-Channel MOSFET via the diode, a second motor coil, and a positive voltage source;
a directional switch;
a first hall effect sensor connected to the first motor coil, the directional switch, and the second p-channel MOSFET; and
a second hall effect sensor connected to the directional switch, the first motor coil, and the second p-channel MOSFET,
wherein the first Hall effect sensor and the second Hall effect sensor are configured to detect a magnetic field of an electric motor,
wherein the first motor coil is connected to ground and to the second p-channel MOSFET, and
wherein the second motor coil is connected to the positive voltage source and the n-channel MOSFET.

10. The electric motor controller of claim 9, wherein the directional switch includes a manual switch.

11. The electric motor controller of claim 9, wherein the directional switch includes a relay.

12. The electric motor controller of claim 9, wherein the pulse width modulation signal is generated by a discrete signal generator.

13. The electric motor controller of claim 9, wherein the pulse width modulation signal is generated by a processor.

14. The electric motor controller of claim 9, wherein the electric motor is a permanent magnet electric motor.

15. The electric motor controller of claim 9, wherein the electric motor is an electromagnet magnet electric motor.
